(19) United States
(12) Patent Application Publication
(10) Pub. No.: US 2003/0200449 A1
(43) Pub. Date: Oct. 23, 2003

(54) Method of accessing a shared subroutine of computer system

(75) Inventors: Hartmut Droege, Stuttgart (DE); Martin Witzel, Shoenaich (DE)

Correspondence Address: Marilyn Smith Dawkins, International Business Machines Corporation, Intellectual Property Law Department, 11400 Burnet Raod, Austin, TX, 78758, US

(73) Assignee: International Business Machines Corporation

(21) Appl. No.: 10/256,105

(22) Filed: Sep. 26, 2002

(30) Foreign Application Priority Data
Apr. 17, 2002 (DE) 01125849.8

(51) Int. Cl. H04L 9/00

(52) U.S. Cl. 713/189

(57) ABSTRACT

The present invention relates to a method of accessing a shared subroutine (4a, 4b, 4c) being part of a shared library (4) of a computer system (100) that provides an encryption (10) of a parameter list passed to the shared subroutine (4a, 4b, 4c) in order to prevent unauthorized applications (2) from accessing said shared subroutine (4a4b, 4c). The encryption (10) is performed in authorized applications (1, 3), whereas the decryption (30) is performed in the shared subroutine (4a, 4b, 4c).

A variant provides generating a first security information in an authorized application (1, 3), generating a second security information in said shared subroutine (4a, 4b, 4c) and comparing said first security information to said secondary security information to determine whether said shared subroutine (4a, 4b, 4c), may be executed.

The present invention relates to a method of accessing a shared subroutine, in particular a shared subroutine being part of a shared library of a computer system.

In contrast to subroutines linked statically to a specific application, shared subroutines of computer systems can be accessed by various applications of said computer system. State-of-the-art computer systems do not provide for means of sufficiently protecting shared subroutines/shared libraries from being accessed by unauthorized applications.

A state-of-the-art approach of preventing unauthorized applications from accessing shared subroutines is leaving these shared subroutines undocumented. However, by using analysis tools, it is possible to track function calls of an authorized application to the shared subroutine so as to systematically determine valid parameters that can be passed to the shared subroutine.

Accordingly, it is an object of the present invention to provide an improved method of accessing a shared subroutine preventing unauthorized applications from accessing shared subroutines and a computer system capable of performing said method.

According to the present invention, this object is achieved by providing a method of accessing a shared subroutine being part of a shared library of a computer system, characterized by the following steps:

encrypting an original parameter list to obtain an encrypted parameter list,

calling said shared subroutine with said encrypted parameter list,

executing said shared subroutine by

decrypting said encrypted parameter list in said shared subroutine to obtain a decrypted parameter list corresponding to said original parameter list, and by

processing said decrypted parameter list.

The encryption of the original parameter list ensures that a list of valid parameters for calling said shared subroutine cannot be derived from an analysis of e.g. a multitude of subroutine calls without any further effort such as decrypting the parameters. It is still possible to track subroutine calls of an authorized application, but the encryption provided by the invention must first be deciphered before being able to evaluate the original parameter values of the shared subroutine.

The step of decrypting said encrypted parameter list in said shared subroutine transforms the encrypted parameters of the shared subroutine to a decrypted parameter list corresponding to said original parameter list. After the step of decrypting, the decrypted parameters forming the decrypted parameter list are processed by the shared subroutine.

Parameters passed to the shared subroutine by an unauthorized application calling said shared subroutine will also be interpreted by said shared subroutine as encrypted parameters. The decryption of these parameters, too, results in a decrypted parameter list containing parameter values. Yet, most certainly, these parameter values are invalid since the original parameters passed to the shared subroutine by the unauthorized application have not been encrypted correctly prior to the step of decrypting in the shared subroutine. Consequently, the shared subroutine processes the invalid parameters yielding an error or wrong return values or the like.

An especially advantageous embodiment of the present invention is characterized by said step of encrypting said original parameter list comprising the steps of

requesting a random number from a random number generator,

generating a random number in said random number generator upon said request,

receiving said random number generated in said random number generator, p1 encrypting said original parameter list using an algorithm depending on said received random number,

and wherein said step of decrypting comprises

decrypting said encrypted parameter list using an algorithm depending on said random number.

Using a new random number for each subroutine call to encrypt said original parameter list yields a different form of said encrypted parameter list for each subsequent subroutine call, even if the parameters of the original parameter list do not change.

Hence, it is practically impossible to obtain a relation between the parameter values of the original parameter list and the encrypted parameter list, even if automatically analysing a multitude of subroutine calls.

Instead of a random number, it is also possible to include another variable element in the step of encryption and/or decryption. Such an element could be a simple counter selecting one of various encrypting algorithms or influencing an encryption input parameter. This feature will also yield a different form of the encrypted parameter list for each subsequent subroutine call, even if parameter values themselves do not change.

A further advantageous embodiment of the method according to the invention is characterized by adding an auxiliary parameter to said original parameter list before encrypting said original parameter list and by said step of processing said decrypted parameter list comprising the steps of

comparing said auxiliary parameter to a reference parameter, and

preventing further execution of said shared subroutine if said auxiliary parameter does not have a predetermined relation to said reference parameter.

Adding such an auxiliary parameter is useful if accessing shared subroutines that have an empty parameter list, i. e. that have no parameters at all. A very simple predetermined relation consists in checking said auxiliary parameter and said reference parameter for equality.

Yet another embodiment of the invention is characterized in that said random number generator is contained in said shared library. This is especially advantageous if there are two or more shared subroutines utilizing the method according to the invention in said shared library. These shared subroutines do not have to call an external function to access the random number generator.

Another embodiment of the present invention is characterized in that said random number generator is contained in a separate shared library. This is useful to avoid unnecessary program code if a random number generator is already present in the system or if it is desirable that other applications need not be authorized to access said shared library which contains said shared subroutines. In this case, said shared subroutines must access the random number generator of said external shared library.

A further solution to the object of the present invention is provided by a method of accessing a shared subroutine being part of a shared library of a computer system, characterized by the following steps:

generating a first security information in an authorized application,

calling said shared subroutine and passing said first security information to said shared subroutine,

executing said shared subroutine by

generating a second security information in said shared subroutine,

comparing said first security information to said second security information,

deriving a security level from the result of the comparison, and

processing said shared subroutine in a mode that depends on said security level.

As can be seen, the first security information is generated independently of the second security information.

A further advantageous embodiment of the present invention is characterized in that said step of generating said first security information comprises

requesting a random number

receiving said random number

calculating said first security information with said received random number and with a first secret information contained in said authorized application.

Again, the use of a random number or at least a pseudo-random number obtainable in a computer system, provides a high security standard because of minimum predictability of the form of said security information. Preferably, said second security information is calculated with said random number and a second secret information contained in said shared subroutine.

It is also possible to provide said second secret information within said shared library, but not within each shared subroutine.

A very simple variant of the present invention is characterized in that said first secret information and said second secret information are identical, which leads to identity of said first and said second security information when using the same random number.

A more sophisticated variant is characterized in that said second secret information depends on a security level of said shared subroutine. In this way, it is possible to assign a different second secret information to the respective shared subroutine depending on the access rights in the computer system.

Authorized applications may contain various elements of first secret information and a selection mechanism that determines which first secret information to apply for accessing the corresponding shared subroutine.

It is also possible to choose said first secret information and the way of calculating the first security information such that with a given second security information it is possible to derive a security level from a difference of said first and said second security information.

In this way, an authorized application has a single element of first secret information and a shared subroutine has a single element of second secret information. The security level obtained can be used for controlling access to the shared subroutine. In this variant, it is also possible to store the second secret information in the shared library and not in each shared subroutine of said shared library.

A further advantageous embodiment of the present invention is characterized in that generating said first security information is performed according to a first method of generating, and in that generating said second security information is performed according to said first method of generating, too.

Additionally, a further inventive solution is disclosed in the form of a computer system comprising at least one shared subroutine, which is characterized by being capable of performing the method according to one of the claims.

Another advantageous solution to the object of the invention is presented in the form of a computer program product comprising at least one shared subroutine and at least one application characterized by being capable of performing the method according to one of the claims.

The advantage of a computer system and a computer program product according to the invention is that the following drawback is overcome. Subroutines which contain secret data such as cryptographic routines must be linked statically to the respective applications of state-of-the-art systems in order to efficiently prevent unauthorized applications from calling these subroutines. As a consequence, these subroutines are part of any application requiring the computer program functions provided by the subroutines thus increasing the overall code size of the computer program.

This drawback is overcome by the computer program product and the computer system of the present invention since any unauthorized call of a shared subroutine is prevented thus eliminating the need for linking subroutines statically.

A detailed description of the present invention as well as further advantageous features and embodiments are provided based on the enclosed drawings in which

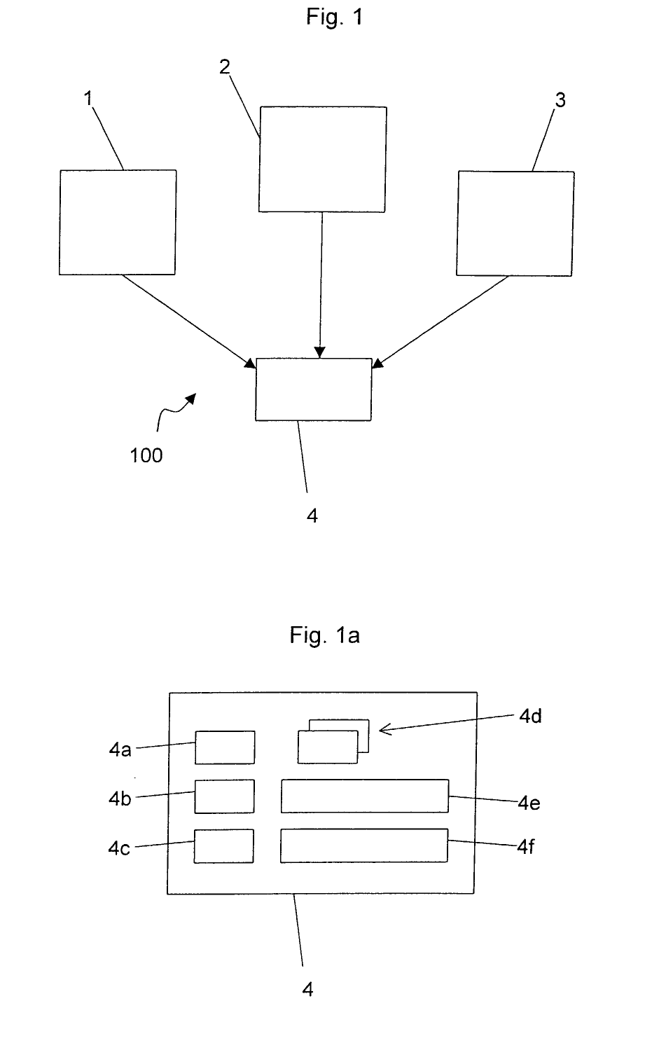

FIG. 1 shows a typical subroutine access scenario,

FIG. 1ashows a detailed diagram of a shared library 4,

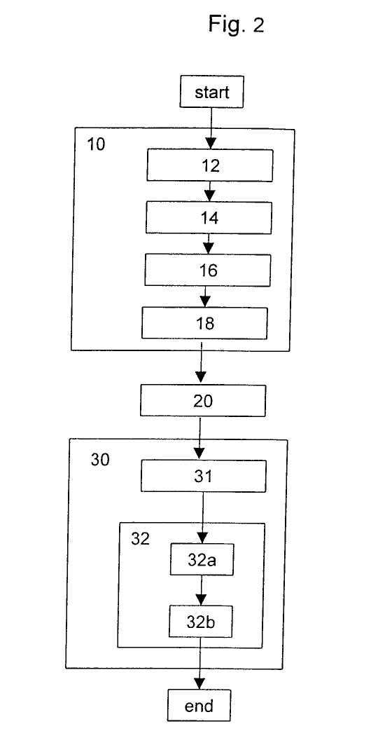

FIG. 2 shows a flow chart depicting the method according to a preferred embodiment of the invention, and

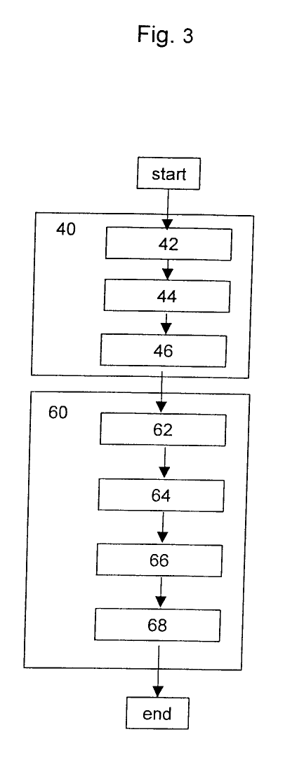

FIG. 3 shows a flow chart of a second embodiment of the method according to the invention.

The subroutine access scenario of FIG. 1 exemplifies a typical situation of a computer system 100 comprising authorized applications 1, 3, an unauthorized application 2 and a shared library 4.

As can be seen from FIG. 1a, the shared library 4 comprises shared subroutines 4a, 4b, 4c and 4d. The shared library 4 further comprises a random number generator 4e and a secret information 4f.

The shared subroutines 4a, . . . , 4d provide computer program functions that are required by both authorized applications 1, 3 of the computer system 100. The shared subroutines 4a, . . . , 4c or the computer program functions provided within, respectively, must not be used by the unauthorized application 2, whereas the shared subroutines 4d provide computer program functions that may be accessed by each of the applications 1, 2, 3.

To prevent the unauthorized application 2 from accessing and invoking the shared subroutine 4a with valid parameters, the method depicted by the flow chart of FIG. 2 is applied. Basically, the method comprises three main steps: encrypting 10 an original parameter list, calling 20 the shared subroutine 4a and executing 30 said shared subroutine 4a. A detailed description of the method is given after the following presentation of the basic principle.

The original parameter list contains a number of parameters the shared subroutine 4a has to be supplied with for execution. Calling the shared subroutine 4a with invalid parameter values usually leads to undefined behaviour during execution of the shared subroutine 4a.

For an unauthorized application 2 it is not possible to perform the encryption 10 of the original parameter list, since the corresponding encryption algorithm is secret and only implemented in the authorized applications 1, 3. The encryption algorithm is not available in the unauthorized application 2.

Within execution 30, the shared subroutine 4a performs the step of decrypting 31 each time being called by any of the applications 1, 2, 3. This results in an invalid parameter list after decryption 31 in case of being called by the unauthorized application 2 with an original parameter list that has not been encrypted according to the aforementioned secret encryption algorithm prior to calling 20 the shared subroutine 4a.

The invalid parameter list contains parameter values depending on the parameter values of the original parameter list provided by the unauthorized application 2 and the decryption algorithm. The decryption algorithm too, is secret and unavailable in the unauthorized application 2. Therefore, the unauthorized application 2 cannot predict the parameter values of the invalid parameter list, i.e. the unauthorized application 2 cannot call the shared subroutine 4 with defined and valid parameter values. Accordingly, the unauthorized application 2 cannot access computer program functions provided by the shared subroutine 4a in a controlled manner. Likewise, the other shared subroutines 4b, 4c of the shared library 4 are protected.

Deciphering the encryption algorithm by executing an authorized application 1, 3 many times with the same or similar parameter values becomes virtually impossible by including a variable in the encryption algorithm. The additional variable can be a simple counter variable or the like influencing the encryption 10 in such a way that encrypted parameter lists of subsequent executions of an authorized application 1, 3 will not be identical, even if the parameter values do not change.

A special case of including a variable in encryption 10 is the application of a random number to the step of encrypting 10. This is achieved by requesting 12 in the authorized application 1 a random number from the random number generator 4e of the shared library 4. Upon this request 12, the random number generator 4e generates 14 a random number, or pseudo-random number, respectively, that is returned to the authorized application 1, which, after receiving 16, uses the random number to encrypt 18 the original parameter list.

As already explained above, the encrypted parameter list is then passed to the shared subroutine 4a. The shared library 4 has temporarily saved the previously generated random number in order to apply it to the decryption 31. Without the correct random number already used for encryption 18, a correct decryption 31 is not possible.

After decryption 31, the decrypted parameter list is processed 32. For accessing computer program functions of the shared subroutine 4a that require no parameters, it is possible to slightly modify the corresponding program code of the respective computer program function by adding an auxiliary parameter to the parameter list of the computer program function.

During processing 32, the auxiliary parameter is compared 32a to a reference parameter available in the shared subroutine 4a, and further execution of the shared subroutine 4a, or the specific computer program function, respectively, is prevented 32b, if said auxiliary parameter does not have a predetermined relation such as equality, for instance, to said reference parameter.

Introducing the auxiliary parameter enables applying the presented access control method for shared subroutines 4a, . . . , 4c even to computer program functions with empty parameter lists.

Another advantage is the reduced complexity of the computer system 100. Computer program functions that are used in many authorized applications 1, 3 of the computer system 100 can be put together in one shared library 4 without sacrificing security regarding access of unauthorized applications 2.

Computer program functions containing secret algorithms must no longer be linked statically to the respective authorized applications 1, 3. Thus, a computer program product with a shared library 4 and various applications 1, 2, 3 accessing the shared library 4 requires less space on a storage medium.

A further method according to the invention is depicted in FIG. 3. This method comprises generating 40 a first security information in the authorized application 3, calling (step not shown in FIG. 3) the shared subroutine 4b (FIG. 1) and executing 60 the shared subroutine 4b.

According to FIG. 3, the first security information is calculated 46 in the authorized application 3 after requesting 42 and receiving 44 a random number from a random number generator 4e of the shared library 4 (FIG. 1). The received random number and a secret information contained in the authorized application 3 are used for calculation 46.

The first security information is passed to the shared subroutine 4b in the step of calling the shared subroutine 4b.

Within said shared subroutine 4b, during execution 60, a second security information is generated based on the random number previously generated by the random number generator 4e of the shared library upon said request 42. The generation 62 of the second security information is based on a second secret information 4f (FIG. 1) contained within the shared library 4.

After comparing 64 the first security information and the second security information, a security level is derived 66 from the result of the comparison 64. A simple variant just prevents further execution 68 of the shared subroutine 4b if the first and the second security level are not identical.

An even more elaborate variant of processing 68 can provide/prohibit access to certain computer program functions of the shared subroutine 4b, if the security level has a special value/is below a predefined limit.

It is also possible to provide several authorized applications 1, 3 with a plurality of first secret information elements, each of which is suitable for accessing a different shared subroutine 4a, 4b, 4c. In this case, each of the shared subroutines is equipped with a second secret information depending on the level of protection required for the shared subroutine.

As already mentioned, it is possible to put the second secret information/a plurality of second secret information elements in the shared library 4. However, it is also possible to store said second secret information (elements) directly in the shared subroutines 4a, 4b, 4c.

1. Method of accessing a shared subroutine (4a, 4b, 4c) being part of a shared library (4) of a computer system (100), characterized by the following steps:
encrypting (10) an original parameter list to obtain an encrypted parameter list,
calling (20) said shared subroutine (4a, 4b, 4c) with said encrypted parameter list,
executing (30) said shared subroutine (4a, 4b, 4c) by
decrypting (31) said encrypted parameter list in said shared subroutine (4a, 4b, 4c) to obtain a decrypted parameter list corresponding to said original parameter list, and by
processing (32) said decrypted parameter list.

2. Method according to claim 1, wherein an auxiliary parameter is added to said original parameter list before encrypting (10) said original parameter list, and wherein said step of processing (32) said decrypted parameter list comprises steps of
comparing (32a) said auxiliary parameter to a reference parameter and
preventing (32b) further execution of said shared subroutine (4a, 4b, 4c) if said auxiliary parameter does not have a predetermined relation to said reference parameter.

3. Method according to claim 2, characterized in that said predetermined relation is equality.

4. Method according to claim 2, characterized in that said original parameter list is empty.

5. Method according to claim 1, wherein said step of encrypting (10) said original parameter list comprises
requesting (12) a random number from a random number generator (4e),
generating (14) a random number in said random number generator (4e) upon said request (12),
receiving (16) said random number generated in said random number generator (4e),
encrypting (18) said original parameter list using an algorithm depending on said received random number,
and wherein said step of decrypting (31) comprises
decrypting (31) said encrypted parameter list using an algorithm depending on said random number.

6. Method according to claim 5, characterized in that said random number generator (4e) is contained in said shared library (4).

7. Method according to claim 5, characterized in that said random number generator (4e) is contained in a separate shared library.

8. Method of accessing a shared subroutine (4a, 4b, 4c) being part of a shared library (4) of a computer system (100), characterized by the following steps:
generating (40) a first security information in an authorized application (1, 3),
calling said shared subroutine (4a, 4b, 4c) and passing said first security information to said shared subroutine (4a, 4b, 4c),
executing (60) said shared subroutine (4a, 4b, 4c) by
generating (62) a second security information in said shared subroutine (4i a, 4b, 4c),
comparing (64) said first security information to said second security information,
deriving (66) a security level from the result of the comparison (64)
processing (68) said shared subroutine in a mode that depends on said security level.

9. Method according to claim 8, wherein said step (40) of generating said first security information comprises
requesting (42) a random number
receiving (44) said random number
calculating (46) said first security information with said received random number and with a first secret information contained in said authorized application (1, 3).

10. Method according to claim 9, wherein said step (62) of generating a second security information comprises
calculating said second security information with said random number and with a second secret information contained in said shared subroutine (4a, 4b, 4c).

11. Method according to claim 10, characterized in that said first secret information and said second secret information are identical.

12. Method according to claim 10, characterized in that said second secret information depends on a security level of said shared subroutine (4a, 4b, 4c).

13. Method according to claim 8, characterized in that generating (40) said first security information is performed according to a first method of generating, and in that generating (62) said second security information is performed according to said first method of generating, too.

14. Computer system (100) comprising at least one shared subroutine (4a, 4b, 4c), characterized by being capable of performing the method of:
encrypting (10) an original parameter list to obtain an encrypted parameter list,
calling (20) said shared subroutine (4a, 4b, 4c) with said encrypted parameter list,
executing (30) said shared subroutine (4a, 4b, 4c) by
decrypting (31) said encrypted parameter list in said shared subroutine (4a, 4b, 4c) to obtain a decrypted parameter list corresponding to said original parameter list, and by
processing (32) said decrypted parameter list.

15. Computer system (100) comprising at least one shared subroutine (4a, 4b, 4c), characterized by being capable of performing the method of:
generating (40) a first security information in an authorized application (1, 3),
calling said shared subroutine (4a, 4b, 4c) and passing said first security information to said shared subroutine (4a, 4b, 4c),
executing (60) said shared subroutine (4a, 4b, 4c) by
generating (62) a second security information in said shared subroutine (4a, 4b, 4c),
comparing (64) said first security information to said second security information,
deriving (66) a security level from the result of the comparison (64)
processing (68) said shared subroutine in a mode that depends on said security level.

16. Computer program product on a computer usable medium having computer readable program code means comprising at least one shared subroutine (4a, 4b, 4c) and at least one application (1), characterized by being capable of performing:
encrypting (10) an original parameter list to obtain an encrypted parameter list,
calling (20) said shared subroutine (4a, 4b, 4c) with said encrypted parameter list,
executing (30) said shared subroutine (4a, 4b, 4c) by
decrypting (31) said encrypted parameter list in said shared subroutine (4a, 4b, 4c) to obtain a decrypted parameter list corresponding to said original parameter list, and by
processing (32) said decrypted parameter list.

17. Computer program product on a computer usable medium having computer readable program code means comprising at least one shared subroutine (4a, 4b, 4c) and at least one application (1), characterized by being capable of performing:
generating (40) a first security information in an authorized application (1, 3),
calling said shared subroutine (4a, 4b, 4c) and passing said first security information to said shared subroutine (4a, 4b, 4c),
executing (60) said shared subroutine (4a, 4b, 4c) by
generating (62) a second security information in said shared subroutine (4a, 4b, 4c),
comparing (64) said first security information to said second security information,
deriving (66) a security level from the result of the comparison (64)
processing (68) said shared subroutine in a mode that depends on said security level.
